(19) United States
(12) Patent Application Publication
(10) Pub. No.: US 2019/0179407 A1
(43) Pub. Date: Jun. 13, 2019

(54) PLATFORM AND METHOD FOR ASSESSMENT AND FEEDBACK IN VIRTUAL, AUGMENTED, AND MIXED REALITY

(71) Applicant: You Are Here, LLC, Atlanta, GA (US)

(72) Inventors: Alan Read Ziegler, Atlanta, GA (US); John Colby Buzzell, Atlanta, GA (US); Alyssia Thien-Nga Maluda, Atlanta, GA (US)

(21) Appl. No.: 16/279,005

(22) Filed: Feb. 19, 2019

Related U.S. Application Data
(63) Continuation-in-part of application No. PCT/US17/47633, filed on Aug. 18, 2017.

(51) Int. Cl. G06F 3/01

(52) U.S. Cl. CPC G06F 3/011

(57) ABSTRACT

Systems and methods for collecting quantitative or qualitative data. An immersive reality experience is provided to users and data is collected from the users during the experience. Collecting data may be performed while users are interacting with the experience. Users may be questioned during the experience and responses collected. Interaction behavior may be monitored during the experience and collected. A platform may be provided and used: in providing the experience, to collect the data, or to report, publish, or transmit data. A 360 degree photograph or video, a hologram, a two-dimensional or three-dimensional format, or two-dimensional or three-dimensional positional data, human-machine interaction generated by computer technology, Virtual Reality (VR), Augmented Reality (AR), Mixed Reality (MR), or an application programming interface may be used. Research may be conducted, or the experience may be hosted by a third-party or proactively pushed. Questions may be displayed and responses measured.

### RELATED PATENT APPLICATIONS

This patent application is a continuation-in-part (CIP) patent application of, and claims priority to, Patent Cooperation Treaty (PCT) patent application number PCT/US17/47633, filed Aug. 18, 2017, IMMERSIVE AND MERGED REALITY EXPERIENCE/ENVIRONMENT AND DATA CAPTURE VIA VIRTUAL, AUGMENTED, AND MIXED REALITY DEVICE, having the same inventors and assignee, which claims priority to U.S. Provisional Patent Application Ser. No. 62/377,833, VIRTUAL EXPERIENCE AND DATA CAPTURE VIA MOBILE DEVICE, filed on Aug. 22, 2016, which has at least one inventor in common. The contents of the priority PCT and provisional patent applications are incorporated herein by reference. If there are any conflicts or inconsistencies between this patent application and the incorporated patent applications, however, this patent application governs herein.

### FIELD OF THE INVENTION

Various embodiments of this invention relate to Virtual, Augmented, and Mixed Reality technology. Further, many embodiments concern software and computer implemented methods. Still further, certain embodiments relate to systems and methods for collecting, organizing, and analyzing information such as response data from participants.

### BACKGROUND OF THE INVENTION

Computer systems have been used to collect and manage data, including feedback from many individuals. Further, Virtual, Augmented, and Mixed Reality has been used for various purposes ranging from entertainment to conveying information including for planning retail store space layout, for example. Various examples of use of immersive realities are described in U.S. Patent Application publication numbers 2012/0223943, 2013/0083011, 2013/0117377, 2014/0253743, and 2016/0019717, for instance. These documents also describe examples of needs and benefits of such systems and the use of immersive reality. Needs and opportunities for improvement exist for partially or fully providing one or more of these needs or potential benefits. Room for improvement exists over the prior art in these and various other areas that may be apparent to a person of ordinary skill in the art, having studied this document.

### SUMMARY OF PARTICULAR EMBODIMENTS OF THE INVENTION

This invention provides, among other things, various systems and methods for collecting (e.g., at least one of) quantitative or qualitative data. Various embodiments provide, for example, as an object or benefit, that they partially or fully address or satisfy one or more of the needs, potential areas for benefit, or opportunities for improvement described herein, or known in the art, as examples. Various embodiments of the invention are described herein, and different benefits of various embodiments may be apparent to a person of ordinary skill in the art. Specific embodiments include, for example, various methods of collecting (e.g., at least one of) quantitative or qualitative data. In a number of embodiments, for example, the method includes at least acts of providing an immersive reality experience (e.g., to one or more users), and collecting (e.g., at least one of) quantitative or qualitative data (e.g., from the one or more users) during the immersive reality experience.

In some embodiments, for example, the collecting of the (e.g., at least one of quantitative or qualitative) data from the one or more users is performed while the one or more users are interacting with the immersive reality experience. Further, in certain embodiments, the method includes prompting the (e.g., one or more) users with questions (e.g., during the immersive reality experience), and collecting responses to the questions. Still further, in particular embodiments, the method includes monitoring interaction behavior (e.g., of the one or more users), for example, during the immersive reality experience, and collecting the interaction behavior.

Further, in various embodiments, the method includes providing a platform (e.g., to the one or more users). In some embodiments, for example, the platform is or includes (e.g., at least one of) a device app, a web portal, a Software Developer Kit (SDK), or software. Further, in a number of embodiments, the providing of the immersive reality experience (e.g., to one or more users) includes using the platform. Still further, in particular embodiments, the collecting (e.g., of the at least one of quantitative or qualitative) data, for instance, from the one or more users, during the immersive reality experience, or both, includes using the platform. Even further, in certain embodiments, the method includes using the platform to (e.g., at least one of) report, publish, or transmit the (e.g., at least one of quantitative or qualitative) data from the one or more users. Moreover, in various embodiments, the method includes at least one of reporting, publishing, or transmitting the at least one of quantitative or qualitative data from the one or more users.

Still further, in a number of embodiments, the immersive reality experience includes at least one 360 degree photograph or video. Even further, in various embodiments, the immersive reality experience is presented in (e.g., at least one of) a two-dimensional format or in a three-dimensional format. Still further, in some embodiments, the immersive reality experience includes (e.g., at least one of) two-dimensional or three-dimensional positional data. Even further still, in particular embodiments, the immersive reality experience includes at least one hologram. Further still, in various embodiments, the immersive reality experience includes at least one human-machine interaction generated by computer technology, for example, that includes (e.g., at least one of) a wearable device or an IoT device. Moreover, in a number of embodiments, the immersive reality experience includes at least one, or all, of Virtual Reality (VR), Augmented Reality (AR), or Mixed Reality (MR), as examples.

In various embodiments, the method includes using an application programming interface, for instance, to conduct research, surveys, or questionnaires within the immersive reality experience. Further, in some embodiments, the immersive reality experience is hosted by a third-party. Still further, in some embodiments, providing the immersive reality experience (e.g., to one or more users) includes proactively pushing the immersive reality experience (e.g., to one or more users). Even further, in some embodiments, collecting the (e.g., at least one of quantitative or qualitative) data, for instance, from the one or more users, for example, during the immersive reality experience includes displaying questions (e.g., during the immersive reality experience) and measuring question responses or interactions. In addition, various other embodiments are also described herein, and other benefits of certain embodiments may be apparent to a person of skill in the field of this invention.

### BRIEF DESCRIPTION OF THE DRAWINGS

FIG. 1 is a flow chart illustrating various examples of (e.g., computerized) methods of collecting data during or within an immersive reality environment or experience;

FIG. 2 is a block diagram illustrating an example of a managed service version of a platform; and

FIG. 3 is a b lock diagram illustrating an example of a licensing model of a platform.

The drawings provided herewith illustrate, among other things, examples of certain aspects of particular embodiments. Other embodiments may differ. Various embodiments may include aspects shown in the drawings, described in the specification (including the claims), known in the art, or a combination thereof, as examples.

### DETAILED DESCRIPTION OF EXAMPLES OF EMBODIMENTS

This patent application describes, among other things, examples of certain embodiments, and certain aspects thereof. Other embodiments may differ from the particular examples described in detail herein. Various embodiments include systems and methods for creating immersive reality experiences or environments, for example, that allow participants or users to engage and interact with immersive reality content. Further, in a number of embodiments, a customer purchases, stores, or reserves data, or a combination thereof. Still further, various embodiments include: virtual reality, augmented reality, mixed reality, immersive reality, merged reality, “X” reality (e.g., XR,) or a combination thereof, for instance, on a device (e.g., a mobile device or a stationary device). Even further, various embodiments include analysis (e.g., of obtained data). As used herein, an “immersive reality environment” includes VR, AR, MR, XR, or a combination thereof. Further, as used herein, an “immersive reality experience” includes VR, AR, MR, XR, or a combination thereof. Different embodiments include, one, two, three, or all of VR, AR, MR, or XR. Even further still, certain embodiments include one, two, or all of VR, AR, or MR. Some embodiments further include other digital experiences that include a digital addition (e.g., visual, aural, haptic, inertial, positional, or other sensory addition) to an experience of physical reality. Still further, as used herein, “immersive” can include audio/aural, touch/haptic, positional, inertial, or other sensory stimulation (e.g., provided digitally).

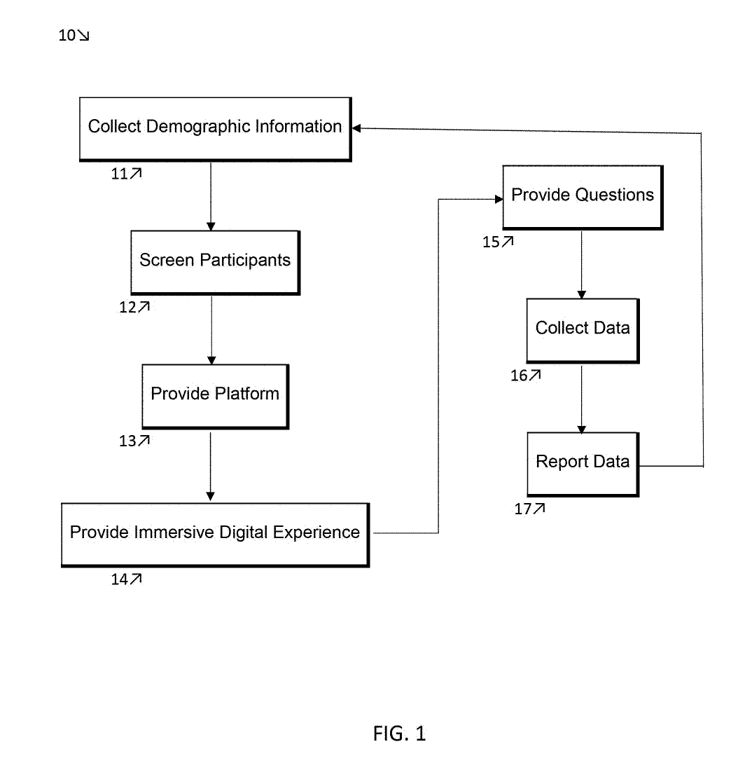

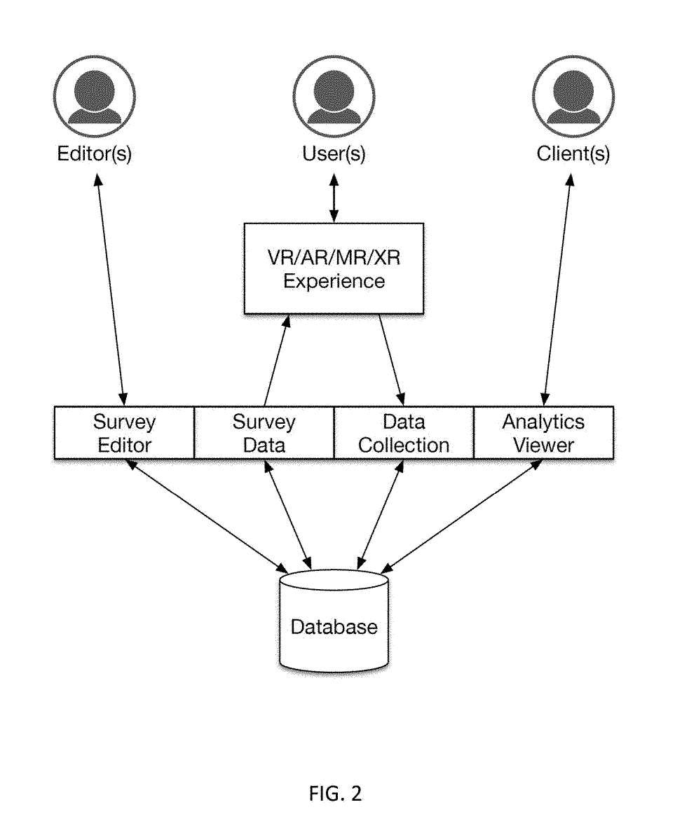

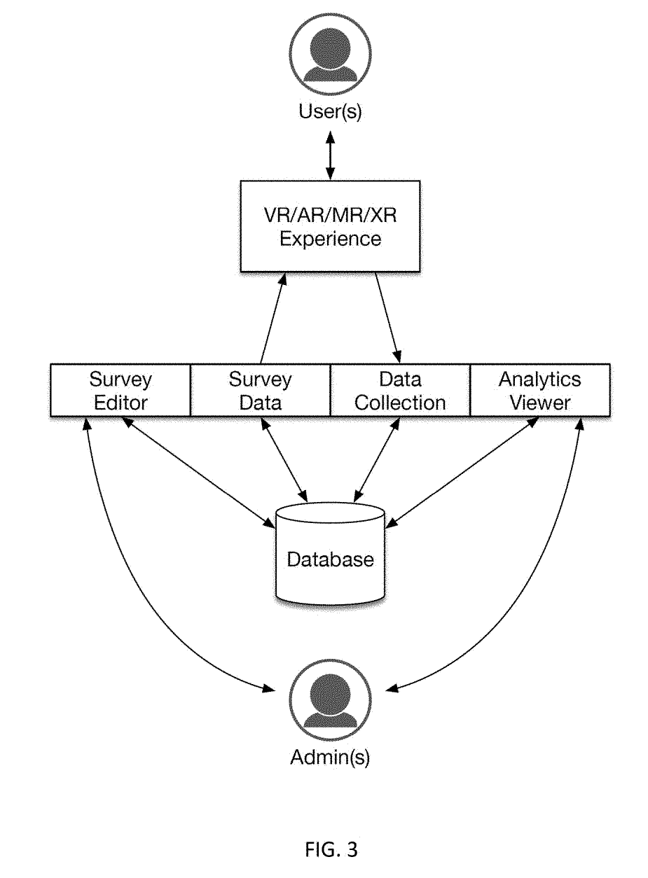

Various embodiments include systems and methods for collecting (e.g., at least one of quantitative or qualitative) data. Particular embodiments, for example, include various methods of collecting (e.g., at least one of quantitative or qualitative) data that include providing an immersive reality experience or environment to one or more users and collecting the (e.g., at least one of quantitative or qualitative) data from the one or more users during the immersive reality experience or environment. FIG. 1, for example, illustrates method 10, which is an example of a method of collecting (e.g., at least one of quantitative or qualitative) data that includes providing an immersive reality experience or environment (e.g., in act 14), for instance, to one or more users. Further, FIG. 2 shows an example of a managed service version of a platform and FIG. 3 shows an example of a licensing model. In the embodiment illustrated (e.g., in FIG. 1), method 10 also includes act 16 of collecting (e.g., at least one of quantitative or qualitative) data, for example, from the one or more users, for instance, during the immersive reality experience or environment. In this context, “collecting” includes recording, for example, in a database (e.g., shown in FIGS. 2 and 3). In some embodiments, collecting can also (or instead) include sending (e.g., the data), for example, via a computer network. Further, in particular embodiments, collecting includes detecting, measuring, compiling, etc. FIG. 1 illustrates an example of an order in which certain acts can be performed, but in other embodiments, acts may be performed in a different feasible order. Some examples are described herein, or may be apparent from the description herein, but other embodiments may differ. In some embodiments, some acts may be performed concurrently, or some methods may alternate (e.g., back and forth) between certain acts and some or all acts may be repeated, for example, with different participants, content, questions, etc. In the embodiment shown, method 10 further includes act 15 of providing questions (e.g., prompting the one or more users with questions), for instance, during the immersive reality experience or environment (e.g., provided in act 14). In various embodiments, act 16 includes collecting responses to the questions (e.g., provided in act 15). Further, some embodiments include (e.g., in act 16) monitoring or collecting (or both) viewing or interaction behavior, or both, for example, of the one or more users, for instance, during the immersive reality experience or environment (e.g., provided in act 14). Still further, in the embodiment shown, method 10 includes act 17 of reporting the (e.g., at least one of quantitative or qualitative) data, for example, from the one or more users. In some embodiments, for instance, data is presented in one or more file or document types (e.g., reports, etc.), contents (e.g., data, images, video, etc.), presentation formats (e.g., lists, graphs, charts, animations, videos, etc.), recommendations, etc.

Many embodiments are computer implemented and some or all of the acts described herein are contemplated as being performed or implemented with a device or computer, for example, through software. Further, FIG. 1 and method 10, for example, illustrate various methods of collecting (e.g., at least one of quantitative or qualitative) data that include providing a platform, such as a device app, for example, in act 13, for instance, to the one or more users. In some embodiments, for example, the device app is software that is loaded (e.g., in act 13) on the device. In various embodiments, the device is a mobile phone, tablet computer, laptop computer, desktop computer, server, or other computer, for example, with a processor and memory or storage. Still further, various devices are or include other multifunctional portable or wearable electronic devices for example, with a visual display, computing, and networking functions, or a combination thereof, for instance, that are assembled for use as a mobile networked computing device. Further, in particular embodiments, the platform or device app is delivered (e.g., in act 13) to the device via a computer network (e.g., the Internet), a mobile phone network, or both, for example. Various embodiments that include act 13 also include, for example, act 14 of providing an immersive reality experience or environment (e.g., to the one or more users), act 16 of collecting the (e.g., at least one of quantitative or qualitative) data (e.g., from the one or more users, for instance, during the immersive reality experience or environment), or both. Moreover, in a number of embodiments, act 14 of providing of the immersive reality experience or environment (e.g., to the one or more users), act 16 of collecting of the (e.g., at least one of quantitative or qualitative) data (e.g., from the one or more users, during the immersive reality experience or environment, or both), or both such acts, are performed using the platform or device app (e.g., provided in act 13).

Further, in some embodiments that include act 13 of providing a platform or device app, act 16 of collecting the (e.g., at least one of quantitative or qualitative) data includes using the platform or device app provided in act 13. Where an act is described herein as including, or being accomplished, using the platform or device app, in various embodiments, the platform or device app includes computer code, that when executed, performs the act or causes a computer or processor (e.g., within the device) to perform the act. In addition, in some embodiments, act 15 of providing questions or prompting the one or more users, for example, with questions, for instance, during the immersive reality experience or environment, includes using the platform or device app provided in act 13. Moreover, in some embodiments, act 16 of collecting (e.g., at least one of quantitative or qualitative) data or collecting responses to questions (e.g., provided in act 15) includes using the platform or device app provided in act 13. Still further, in some embodiments, the collecting of the (e.g., at least one of quantitative or qualitative) data (e.g., in act 16) includes (e.g., using the platform or device app provided in act 13), monitoring viewing or interaction behavior, for example, of the one or more users, for instance, during the immersive reality experience or environment, collecting the viewing or interaction behavior, or both. In particular embodiments, some or all of these acts or act 16 can be performed, for example, using the platform or device app (e.g., provided in act 13). Further still, certain embodiments that include act 13 further include act 17 of (e.g., at least one of) reporting, publishing, or transmitting the data, for example, from the one or more users, for instance, using the platform or device app (e.g., provided in act 13).

Further still, some embodiments include (e.g., in act 15 of method 10) using an application programming interface (API), for example, to act as a channel to call the content from the cloud to the app or platform. Still further, in certain embodiments, such an immersive reality experience or environment (e.g., provided in act 14) is hosted by a third-party, for example, storing the content and data for use by software (unseen) or people (seen). In some embodiments, Amazon Web Services or Microsoft Azure can be used, as examples. Even further embodiments that are illustrated by method 10 include, for example, various methods of collecting (e.g., at least one of quantitative or qualitative) data that include using an application programming interface (e.g., in act 15) to conduct (e.g., at least one of) research, surveys, or questionnaires on one or more users, for example, within an immersive reality experience or environment (e.g., provided in act 14), for instance, hosted by a third-party.

Even further, various embodiments include collecting demographic information (e.g., act 11 of method 10), for example, on the one or more users. Not all embodiments, however, include collecting demographic information (e.g., act 11 of method 10). In the embodiment illustrated, method 10 also includes act 12 of screening the (e.g., multiple) participants (e.g., users), for instance, based on the demographic information (e.g., collected in act 11). Not all embodiments, however, include screening (e.g., act 12) the one or more users. Moreover, not all embodiments include screening or collecting demographic information. Further, in particular embodiments, the providing of the immersive reality experience or environment (e.g., in act 14), for instance, to the one or more users, is based on, or selected based on, the screening (e.g., in act 12), for example, of the one or more users (e.g., based on the demographic information for instance, collected in act 11).

Still further, in some embodiments, act 14 of providing of the immersive reality experience or environment (e.g., to the one or more users) includes proactively pushing the immersive reality experience or environment (e.g., to the one or more users). In some embodiments, for example, proactively pushing includes sending new immersive environments or other stimuli to empaneled participants. Further still, in many embodiments, the providing of the immersive reality experience or environment (e.g., in act 14, for instance, to the one or more users) includes providing a virtual reality experience (e.g., to the one or more users). Even further, in some embodiments, the method (e.g., 10) or the act (e.g., 16) of collecting the (e.g., at least one of quantitative or qualitative) data includes displaying questions (e.g., in act 15, for instance, during the immersive reality experience or environment provided in act 14), measuring (e.g., in act 16) responses to the questions, or both. Even further still, various embodiments include (e.g., in act 17 of method 10) at least one of reporting, publishing, or transmitting the data (e.g., from the one or more users). In particular embodiments, for example, the immersive reality experience or environment (e.g., provided in act 14) includes a 360 degree video, a 360 degree photograph., three-dimensional geometry, three-dimensional positional data, or a combination thereof. Each different possible combination is a different embodiment. In various embodiments, “three-dimensional geometry” includes computer generated shapes or volumes, for example, that inhabit an immersive reality experience. For example, in particular embodiments, a virtual 3D can of Coca-Cola is shown on a desk and a participant is asked if he or she likes the way it looks. In this example, the virtual cylinder and associated geometric data provides stimuli to which the reaction of the participant can be measured. Further, in various embodiments, “three-dimensional positional data” includes or refers to the participant's position, for example, in space relative to an origin point in space (e.g., x, y, and z). For instance, in particular embodiments, a virtual car is shown on the ground in front of a participant, and observations are made as to whether the participant walked closer to it, how close, walked around it, etc. Various embodiments track the participant's changing position, for example, as a measure of engagement.

Various embodiments include providing a virtual experience (e.g., in act 14), for example, to one or more users and collecting (e.g., at least one of quantitative or qualitative) data (e.g., in act 16) from the one or more users (e.g., during the virtual experience). Further, some embodiments include prompting the one or more users with questions (e.g., in act 15), for instance, within the virtual experience, and (e.g., in act 16) collecting responses to the questions, monitoring the participants viewing behavior during the virtual experience (e.g., within the immersive reality experience or environment) and collecting the participants viewing behavior, or both. For example, in certain embodiments, a method for collecting(e.g., at least one of quantitative or qualitative) data (e.g., 10) includes providing (e.g., in act 13) a platform or device app to one or more users, providing a virtual experience (e.g., in act 14) to the one or more users via the device app, and collecting data (e.g., in act 16) from the one or more users during the virtual experience (e.g., using the device app). In some embodiments, the act (e.g., 16) of collecting (e.g., at least one of quantitative or qualitative) data includes, or is preceded by, prompting the participants with questions (e.g., in act 15), for instance, during the virtual experience (e.g., within the immersive reality experience or environment provided in act 14) and collecting responses (e.g., in act 16) to the questions. Further, in some embodiments, the act of collecting data (e.g., 16) includes monitoring the participants viewing behavior, for example, during the virtual experience (e.g., within the immersive reality experience or environment) and collecting the participants viewing behavior. Further still, in some embodiments, the method further includes reporting the data (e.g., in act 17, for instance, from the one or more users (e.g., using the platform or device app provided in act 13).

In various embodiments, Augmented Reality or AR includes a real-time view of the real world that is combined with digital elements meant to enhance or “augment” its presentation. For instance, in particular embodiments, a mobile app for tourism uses a device's camera viewfinder with an overlay showing nearby points of interest. This is an example of AR. Further, in a number of embodiments, Mixed Reality” includes merging of real and virtual objects, for example, in a single presentation. Examples of MR include digital presentations of virtual objects that can interact with the real world. For instance, a virtual ball that rolls along a real floor and bounces off of a real wall is an example of MR. Further still, in different embodiments, Extended Reality includes various combinations of real and virtual environments and human-machine interactions generated by computer technology, for example, wearables, or IoT devices. In various embodiments, XR includes, but is not limited to, Virtual Reality (VR), Augmented Reality (AR), Mixed Reality (MR), or a combination thereof.

Various embodiments are or include a system or method for managing, enabling, displaying, capturing, authenticating, storing, analyzing, or a combination thereof, prompted or unprompted interaction (e.g., at least one of quantitative or qualitative) data, or both, for instance, related to immersive reality experiences, environments, or both. Method 10 is an example. Systems can include, for example, hardware, software, or both, for instance, that implement a method (e.g., method 10). In various embodiments, selection of specific hardware, specific software code, or both, are within the capabilities of a person of ordinary skill in the art. Many embodiments include an application display, and various embodiments ingest VR, AR, MR, or XR content, or a combination thereof, for example, for users to overlay (e.g., prompted) questions, for instance, at designated locations (e.g., within the VR, AR, MR, or XR environment, for instance, provided in act 14). Further, many embodiments include content management. For example, in some embodiments, interactive (e.g., VR, AR, MR, or XR) environments are created and managed (e.g., in act 14). Still further, in some embodiments, “XR” stands for “eXtended Reality”.

Still further, some embodiments are enabled by API. For example, in some embodiments, API calls for interactive (e.g., VR, AR, MR, or XR) environments, (e.g., via a VR, AR, MR, or XR app, for instance, Oculus GO application or another platform). Even further, some embodiments include participant authentication (e.g., in act 12). In some embodiments, for example, participants verify identity with a verification code, for instance, before accessing an (e.g., immersive digital) environment (e.g., provided in act 14). Further still, various embodiments include (e.g., at least one of quantitative or qualitative) data capture (e.g., act 16). For example, in some embodiments, responses are collected (e.g., in act 16) in real time. Even further still, a number of embodiments include data storage (e.g., in act 16). For instance, in some embodiments information from one or more users (e.g., collected in act 11), collected (e.g., at least one of quantitative or qualitative) data (e.g., collected in act 16), or both, are stored in a database (e.g., on the device or on a server). Moreover, certain embodiments include data analysis, visualization, or both (e.g., in act 16 or 17). For example, in some embodiments, captured (e.g., at least one of quantitative or qualitative) data is aggregated into reports, visualization dashboards are made available, for instance, for further analysis in an admin panel, or both. In particular embodiments, for example, third party apps call the API of the embodiment, for example, to inject certain technology into their experience. In many embodiments, the third party would pay to retrieve the data, for instance.

Various embodiments include content management, are API enabled, or both. For example, in some embodiments, an editor (e.g., not necessarily the one or more users previously described) uploads VR, AR, mixed, or “X” reality content, as examples, to an admin panel, for instance, on a site. Further, in various embodiments, the site or system generates an interactive, immersive, or merged reality environment, as examples (e.g., provided in act 14). Still further, in some embodiments, API calls for the environment from an AR, VR, MR, or XR app (or a combination thereof), for instance, and delivers (e.g., in act 14) the environment to one or more users or participants. Even further, in a number of embodiments, the one or more users or participants engages with the environment, for example, through prompted questions (e.g., provided in act 15). Even further still, in particular embodiments, unprompted or passive behavior (e.g., eye movement, head movement, idle time for head movement, etc.) is (e.g., also) recorded (e.g., in act 16). For example, some embodiments track the X1, Y1 of where the participant looks. Other versions track the X2, Y2 of where the one or more users or participants look and the X3, Y3, Z3, for instance, of where the one or more users or participants move (or as applies to immersive reality experience controllers or accessories). Further, certain embodiments track the positions of arms, elbows, wrists, hands or fingers, or a combination thereof, heartbeat, blood pressure, blood glucose levels, other biometric indicators, etc. Various embodiments include display (e.g., act 14), authentication, (e.g., at least one of quantitative or qualitative) data capture (e.g., act 16), data storage, data analysis and visualization, or a combination thereof (e.g., in act 16 or 17).

In some embodiments, participant identity is verified (e.g., in act 12), for example, via a verification code, for instance, before entering or being provided with the environment (e.g., in act 14). Various methods of authentication include, as examples, activation code, user name and password, password alone, unique link, QR code or other digital code, biometric scan, location, IP address, etc. In a number of embodiments, for example, responses are recorded and aggregated (e.g., in act 16), for instance, in real time, collected participant information and responses are stored in a database, aggregated data is synthesized and prepared as reports or dashboards with visualizations (e.g., in act 17, for instance, for further analysis), or a combination thereof. Further, various embodiments include an app, for example, an AR, VR. MR, or XR app (e.g., provided in act 13). In some embodiments, for example, a participant downloads an AR, VR, or MR app, or an XR app, as another example, (e.g. the Oculus GO or smart phone app), for instance, in act 13. In various embodiments, a “code” is or includes a unique user or study code (or both), for example, that instructs the app to load a particular immersive environment or other stimuli.

Various embodiments (e.g., of method 10) can be used for: spatial design, customer experience, venue design, product design, consumer behavior, consumer preference, or a combination thereof, as examples. Further, various methods include acts of spatial design, customer experience evaluation or design, venue design, product design, consumer behavior, or a combination thereof, as examples. In a number of embodiments, for example, an admin will upload VR, AR, MR, or XR content, for example, or 360 video images. Further, some embodiments include AR, MR, or both. Particular embodiments include, for example, interacting with an AR environment and tagging locations for AR interactions. In some embodiments, for example, within a site, a user will, overlay question prompts (e.g., for act 15) onto designated areas of the content (e.g., to be provided in act 14) for participant or user response (e.g., collected in act 16). In different embodiments, question types (e.g., for act 15) may include: scale ranking (e.g., 1-5), multiple choice (e.g. Choose 3 of the 5 . . . ), conditional questions, or a combination thereof, as examples. Some embodiments include demo videos or images within questions (e.g., provided in act 15), as another example. Further still, in certain embodiments, capabilities within the content upload environment include progress functionality, for instance, to indicate complete or incomplete tasks. Still further, some embodiments include flat or 3D preview functionality. Even further, in various embodiments, from the created content, an interactive environment is generated for participant engagement (e.g., in act 14). Even further still, various embodiments include content upload, question creation (e.g., for act 15), a preview function, participant engagement, or a combination thereof.

In many embodiments, a participant downloads a VR/AR/MR/XR app (e.g. Oculus GO or smart phone application for use in Google Cardboard or otherwise, for instance, in act 13) to access the platform environment (e.g., provided in act 14). Further, API is enabled, in some embodiments, for instance, through the VR/AR/MR/XR app (e.g., provided in act 13). Still further, in some embodiments, the API calls the interactive experience or environment (e.g., provided in act 14). Further still, some embodiments include participant or user authentication (e.g., in act 12). For example, in particular embodiments, one or more participants or users must verify their identity before accessing the experience or environment (e.g., provided in act 14). Even further, in some embodiments, participants use compatible accessories to engage with the interactive environment (e.g., provided in act 14), for example, for VR, participants may use Google Cardboard, Samsung Gear, Google Daydream, Oculus GO, Oculus Rift, HTC Vive, etc. For AR, a code may be used (e.g., in act 12), for example, a headset such as the Microsoft HoloLens or an external accessory may be used. Microsoft HoloLens, however, may apply (e.g., typically) to MR. A smart phone (e.g., iPhone) can be used, in a number of embodiments, for AR, for example. In some embodiments, for example, the one or more participants or users use the AR app and content populates either per placed geo tags or brings in content (e.g. brings in a chair into an empty room). Even further still, in some embodiments, an external accessory may be used. Moreover, in a number of embodiments, for MR or XR, participants use compatible accessories to engage with the interactive environment (e.g., provided in act 14).

In various embodiments, for (e.g., at least one of quantitative or qualitative) data capture (e.g., act 16), within the environment (e.g., provided in act 14), prompted questions appear (e.g., provided in act 15) and participants choose answers, confirm final choices, or both (e.g., in act 16). Some embodiments also monitor unaided behavior (e.g. heat mapping), for instance, in act 16. Concerning data storage, in some embodiments, one or more participants or users information and responses are collected (e.g., in act 16) and stored within a database. Further, concerning data analysis and visualization, in some embodiments, recorded responses are aggregated, presented, or both, for example, in exportable reports or dashboards, for instance, for further analysis (e.g., in act 17). Moreover, some embodiments use recorded speech. Even further, some embodiments utilize speech-to-text translation. Various embodiments are or provide a platform designed to ingest content, for example, including 360 video and questions (e.g., aided or unaided), for instance, for participant or user interaction (e.g., provided to participants in acts 14 and 15). Still further, various embodiments collect (e.g., at least one of quantitative or qualitative) data in real time (e.g., in act 16). Certain embodiments include a back end with data capture and analysis capabilities.

In various embodiments, software, such as an app for a device (e.g., provided in act 13), is a core component of the solution. In some embodiments, for example, the software provides for the (e.g., virtual experience) content to be securely delivered (e.g., in act 14) to specific recipients, for instance, via smartphones, tablets, or other “smart” devices (e.g., OS or Android). Other examples (e.g., of various devices) are described herein (e.g., in paragraph 0015). Further, in some embodiments, once recipients or participants are qualified (e.g., based on demographic, psychographic, or behavioral criteria, or a combination thereof, for instance, in act 12), they are permitted or facilitated to download the content, or the content is provided to them (e.g., in act 14), for example, via the platform, software, or app (e.g., provided in act 13). Still further, in certain embodiments, participants then use Oculus GO or Google Cardboard and smart phone or some other similar immersive and/or merged experience platform or device to fully engage with the content (e.g., provided in act 14). Even further, in a number of embodiments, for instance, during a viewing, session, focus group, or other in-person intercept, one or more users or participants are prompted with questions (e.g., in act 15, for instance, via the app provided in act 13), respond to prompted questions, pose questions, make comments of their own, or a combination thereof. Further still, in various embodiments, the software or app (e.g., provided in act 13) collects the response/input and profile data (e.g., in act 16), pushes it (e.g., in act 17) to a cloud-based server for storage and analysis, or both, as examples.

In a number of embodiments, an app is provided (e.g., in act 13) via a common app marketplace such as Apple App Store/iTunes, Google App Store/Google Play, or Oculus Store, as examples. Further, in some embodiments, once downloaded (e.g., in act 13), the app prompts or allows for participants or members to sign-up to be part of a community. Moreover, in particular embodiments, members are prompted (e.g., in act 11) to create a member profile which, in some embodiments, contains various demographic, psychographic, and behavioral information, as examples. Still further, in some embodiments, member sign-ups and profiles (e.g., collected in act 11) are pushed to a central cloud-based server which stores the (e.g., all) profile information. Even further, in certain embodiments, the app (e.g., provided in act 13) invites qualified members (e.g., screened in act 12) to participate in specific immersive reality experiences (e.g., provided in act 14). In some embodiments, additional screening questions may also be asked (e.g., in act 12, for instance, by or through the app provided in act 13) before members are provided certain content or granted permission to download content (e.g., provided in act 14). In some embodiments, answers to such questions may be required (e.g., in act 12) in order for one or more users or participants to proceed. In a number of embodiments, once approved, immersive and/or merged experience (VR, AR, etc.) content is made available for members to download (e.g., in act 14). Further still, in various embodiments, instructions are provided (e.g., in act 14) to help members walk through the download process or platform use. In various embodiments, Google Cardboard (or equivalent) is provided to members so that they may fully engage and interact with the content (e.g., provided in act 14).

Data (e.g., at least one of quantitative or qualitative) capture is accomplished in a number of embodiments (e.g., in act 16). For example, in some embodiments, an app (e.g., provided in act 13) prompts participants or members for response input/feedback, for instance, during the immersive reality experience session (e.g., in act 15). In some embodiments, prompts may solicit close-end or open-ended responses, as examples, or other input such as preferences, selections, reservation/purchase information, or a combination thereof. In particular embodiments, (e.g., all) response/input data is captured (e.g., in act 16) and transferred (e.g., in act 17), for example, to a cloud-based server, where it can be accessed and analyzed, for instance, for each immersive reality experience session (e.g., provided in act 14). Moreover, in certain embodiments, communication or moderation is used, for instance. for research or feedback purposes. Various embodiments provide tracking, incentives, or both. For example, in some embodiments, the app (e.g., provided in act 13) provides member usage and participation metrics (e.g., specific sessions, frequency, completion, or a combination thereof). Further, in some embodiments, the metrics may be used for performance and efficiency optimization, to provide participation incentives to members, or both. Even further, in some embodiments, the app (e.g., in act 13) captures member-specific participation and performance metrics (e.g., in act 11), supports a points-based system of incentives, or both, for example.

In various embodiments, potential applications or use-cases for the platform or app (e.g., provided in act 13) include, as examples: education, market research, brand image positioning (e.g., in environment testing), creative concept testing (e.g., advertising, signage, activation, etc.), retail environment simulation (e.g., shopper), hotel & hospitality (e.g., guest), product innovation and concepting (e.g., new product ideas, etc.), product assessment and enhancement (e.g., pre, during, or post development), buyer education and engagement, transportation (e.g., auto, aviation, yachts/boats, RV, commercial transport), recreation and travel (e.g., golf courses, resorts (e.g., beach, ski, etc.), parks, amusement parks, cruises, etc.), tourism (e.g., city tours, convention centers, tradeshows, etc.), hotel and hospitality (e.g., guest room viewing/selection, events, etc.), sports and entertainment (e.g., venue assessment, seat selection, etc.), fashion and apparel (e.g., fashion shows, buyer shows/markets, etc.), real estate assessment (e.g., commercial, residential, warehouse, apartments, assisted living), and architecture and design (e.g., build process, option assessment, etc.). These are examples and some embodiments include, or are used for, other acts or combinations thereof.

In a number of embodiments, an immersive reality experience (e.g., provided in act 14) provides a presentation plus an ability for (e.g., at least one of quantitative or qualitative) data capture (e.g., responses, etc., for instance, in act 16). Further, in certain embodiments, an integrated (e.g., smartphone) app (e.g., provided in act 13) allows for pushing one or more immersive reality experiences to end-participants (e.g., provided in act 14) and capturing response data (e.g., in act 16). Still further, various embodiments provide screening of participants (e.g., in act 12), for example, based on demographics or other information (e.g., age, income, geography, etc., for instance, collected in act 11). Even further, a number of embodiments prompt (e.g., in act 15) for interaction or response, for instance, while engaging in the immersive reality experience (e.g., provided in act 14). Further still, some embodiments include proactively pushing immersive reality experiences and content (e.g., in act 14) to recipients based, for example, on a certain set of attributes, demographics, or recipient criteria (e.g., collected in act 11, screened in act 12, or both). Certain embodiments download content (e.g., provided in act 14) through the app (e.g., provided in act 13, for instance, reactively) and some embodiments include a proactive “intelligent push” capability as well or instead (e.g., in act 14). In some embodiments, this can be a point of distinction versus other alternatives.

In various embodiments, the app (e.g., provided in act 13) provides for a quick initial load. In some embodiments, for example, with AR, a space is taken and then areas are tagged with questions (e.g., for act 15). In certain embodiments, the user views the space (e.g., through their device) and questions then appear through this lens (e.g., provided in act 15). In other embodiments, the platform recognizes specific shapes, items, or packaging and prompts questions or responses. Further, a number of embodiments provide an intuitive, easy-to-use application (e.g., provided in act 13) with simple UIs, for example, consistent with best practices. Further still, various embodiments include a high-quality media viewer, for example, for 360 degree media (e.g., photos, videos, or both). Still further, some embodiments include high-performance UI screen loading and frame rate within compatible devices. Even further, some embodiments include a gamification system, for instance, where participants' participation is tracked, for example, with points or tiered incentives. Even further still, in some embodiments a questionnaire is provided (e.g., provided in act 11 or 15) as part of the core experience (e.g., provided in act 14), for example, with text entry via a device keyboard.

Various embodiments, for example, provide an unauthenticated experience (e.g., provided in act 14), for instance, for casual use with public or demo content. Further, various embodiments provide an authenticated experience, for example, providing members-only content (e.g., provided in act 14). Further still, some embodiments link out to (e.g., up to 36) website URLs. In a number of embodiments, for example, the URLs lead to the device, for instance, as configured by the participant or user. Some embodiments use WebVR technology. For instance, some embodiments link out to (e.g., up to 36) website URLs, displaying, for example, a rendering of HTML, CSS, JavaScript and/or WebVR markup or code. In certain embodiments, WebVR is an example of an alternative delivery mechanism for VR. Some embodiments provide app-delivered experiences, but in other embodiments, apps are not required or not used. For instance, in particular embodiments, a website provides an app-like experience. Many embodiments, however, are accessed through an app, (e.g., provided in act 13) for example, rather than a mobile browser. Still further, in some embodiments, the app provides (e.g., 360 degree) image, video, or both, for instance, or related content, for example, delivered in free-to-download “packs” to authenticated participants, for instance, based on user permissions. In some embodiments, user-friendly content publishing tools are used (e.g., for staff, for instance, CMS or equivalent). Even further, in some embodiments, an (e.g., branded) Oculus GO or “Google Cardboard”™ viewer is offered, for example, which can be distributed to one or more users or participants (e.g., in act 13).

In a number of embodiments, authentication includes Sign-Up, Sign-In, Log Out, and Forgot Password options or commands (e.g., in act 11). Further, in a number of embodiments, industry-standard account security can be used, for example. Still further, data capture (e.g., in act 16) can be performed, in some embodiments, for instance, with a users' questionnaire (e.g., provided in act 15, for instance, form fields, free text entry, audio, video, or a combination thereof). Even further, data capture (e.g., in act 16) can be performed, in a number of embodiments, by capturing participants' viewing behavior. Further still, measurement can be accomplished, in a number of embodiments, actively, for example, via questionnaire or survey data (e.g., completion percent, entries, or free text), or passively, for example, via viewing behavior, for instance, via viewing location, dwell time, or both (e.g., in act 16).

Further, in some embodiments, metrics can include one or more unique users or participants, session length, content downloads (e.g., per participant, total, or both). Even further, in some embodiments, reporting (e.g., in act 17) can be via a responsive web dashboard, for example, that aggregates analytics for client view. Client(s) are shown, for instance, in FIG. 2 and an analytics viewer is shown, for instance, in FIGS, 2 and 3. Still further, in some embodiments, questionnaire data can be viewed as bar graph, chart, or table, for example. Further still, in some embodiments, viewing behavior for a piece of content (e.g., provided in act 14) can be exported or displayed as a “heat map” (e.g., per participant, per segment, total, or a combination thereof). Even further still, in some embodiments, questionnaire data (e.g., collected in act 16) can be exported (e.g., in act 17) to common format (e.g., CSV, Tableau formats, etc.). still further, in some embodiments, questionnaire data is collected and aggregated in real time (e.g., in act 16). Moreover, in some embodiments, distribution (e.g., in act 13) can be accomplished my making the App available on Apple iTunes app store, Google Play app store, Oculus Store, or any combination thereof, as examples. In particular embodiments, compatibility is with iOS version 8.0 & later, Google Cardboard-compatible iOS devices, Android version v4.1 and up, or a combination thereof. Additionally, in some embodiments, devices include Google Cardboard-compatible Android, smart phone, or IoT devices.

Various embodiments include evaluative layers, associated structure, or both. Further, some embodiments are or include a research, assessment, or feedback platform, or a combination thereof, for instance, that interfaces with or across (or both) an immersive experience (e.g., VR/AR/MR/XR) or technologies. Certain embodiments include front end digital overlays, for example, on top of, or in addition to, digital multi-screen experiences or environments, for instance, for data collection of (e.g., prompted or unprompted) questions/answers, gaze/interaction tracking, communication/moderation, or a combination thereof. Further, some embodiments include one or more back end reporting layers. In various embodiments, data includes (e.g., singular or multiple) users' or respondents' reportable quantitative analytics or qualitative inputs, answers, behaviors, communications, or a combination thereof. Further still, certain embodiments include associated data, organization, visualization, analysis, or a combination thereof.

In a number of embodiments, heat mapping reporting outputs (e.g., usually) visualize where users look in those experiences but can apply to where users walk or how they interact, for example, in room-scale VR experiences, in a physical space with digital elements (e.g. VR, AR, or MR), even geographical respondent location information, or a combination thereof. In some embodiments, for instance, specific user or respondent front end interactions can control sequences of particular scenes, questions/answers, or a combination, for example, either fully automated by the platform, or in particular embodiments, manually controlled on the back end, for instance, depending on the specific research use case.

Some embodiments are or include a complete platform. Examples of a managed service version of a platform and a licensing model of a platform are shown in FIGS. 2 and 3. Further, some embodiments are or include one or more parts of a platform, for example, integrated with another system or app. Still further, certain embodiments are a standalone platform, for example, with different types of front end user interfaces (e.g., phone, tablet, VR Head Mounted Device (HMD), computer monitor, eyewear, other screen/display, or a combination thereof), for instance, with infrastructure for reportable data collection. Further still, some embodiments include database server or CDN mechanisms, or both. Examples include prompted questions, and software, programs, or apps, for instance, for creation, modification, organization, reporting, analysis, or a combination thereof, for example, of immersive research user inputs.

Various embodiments include, among other things, various systems and methods for collecting data. Specific embodiments include, for example, various methods (e.g., method 10 shown in FIG. 1) of collecting, for example, quantitative or qualitative data. In a number of embodiments, for example, the method (e.g., 10) includes at least acts of: providing an immersive reality experience (e.g., to one or more users, for, instance, in act 14), and collecting (e.g., at least one of) quantitative or qualitative data (e.g., from the one or more users, for instance, in act 16), for example, during the immersive reality experience.

In some embodiments, for example, the collecting of the (e.g., at least one of quantitative or qualitative) data from the one or more users (e.g., act 16) is performed while the one or more users are interacting with the immersive reality experience (e.g., provided in act 14). Further, in certain embodiments, the method (e.g., 10) includes prompting (e.g., in act 15) the (e.g., one or more) users with questions (e.g., during the immersive reality experience, for instance, provided in act 14), and collecting (e.g., in act 16) responses to the questions (e.g., provided in act 15). FIGS. 2 and 3 each show a VR/AR/MR/XR Experience, which may be examples of an immersive reality experience (e.g., provided in act 14). FIGS. 2 and 3 also show examples of user(s) and Data Collection. Data may be stored, for example, in the Database shown in FIG. 2 or FIG. 3, as examples. Still further, in particular embodiments, the method (e.g., 10) includes monitoring interaction behavior (e.g., of the one or more users, for instance, in act 16), for example, during the immersive reality experience (e.g., provided in act 14), and collecting (e.g., in act 16) the interaction behavior.

Further, in various embodiments, the method (e.g., 10) includes providing a platform (e.g., to the one or more users, for instance, in act 13). In some embodiments, for example, the platform (e.g., provided in act 13) is or includes (e.g., at least one of) a device app, a web portal, a Software Developer Kit (SDK), or software, or a combination thereof, as examples. Further, in a number of embodiments, the providing of the immersive reality experience (e.g., to one or more users, for instance, in act 14) includes using the platform (e.g., provided in act 13). Still further, in particular embodiments, the collecting (e.g., of the at least one of quantitative or qualitative) data, for instance, from the one or more users (e.g., in act 16), during the immersive reality experience (e.g., provided in act 14), or both, includes using the platform (e.g., provided in act 13). Even further, in certain embodiments, the method (e.g., 10) includes using the platform (e.g., provided in act 13) to (e.g., at least one of) report, publish, or transmit (e.g., in act 17) the (e.g., at least one of quantitative or qualitative) data from the one or more users (e.g., collected in act 16). Moreover, in various embodiments, the method (e.g., 10) includes at least one of reporting, publishing, or transmitting (e.g., in act 17) the at least one of quantitative or qualitative data from the one or more users. In some such embodiments, the platform (e.g., provided in act 13) is used, but other embodiments may differ.

Still further, in a number of embodiments, the immersive reality experience (e.g., provided in act 14) includes at least one 360 degree photograph or video. Even further, in various embodiments, the immersive reality experience (e.g., provided in, act 14) is presented in (e.g., at least one of) a two-dimensional format or in a three-dimensional format. Still further, in some embodiments, the immersive reality experience (e.g., provided in act 14) includes (e.g., at least one of) two-dimensional or three-dimensional positional data. Even further still, in particular embodiments, the immersive reality experience (e.g., provided in act 14) includes at least one hologram. Further still, in various embodiments, the immersive reality experience (e.g., provided in act 14) includes at least one human-machine interaction, for instance, generated by computer technology, for example, that includes (e.g., at least one of) a wearable device or an IoT device. Moreover, in a number of embodiments, the immersive reality experience (e.g., provided in act 14) includes at least one, or all, of Virtual Reality (VR), Augmented Reality (AR), or Mixed Reality (MR), as examples. See, for instance, FIGS. 2 and 3.

In various embodiments, the method (e.g., 10) includes using an application programming interface, for instance, to collect (e.g., at least one of quantitative or qualitative) data within the immersive reality experience (e.g., provided in act 14). Further, in some embodiments, the immersive and/or merged reality experience (e.g., provided in act 14) is hosted by a third-party. Still further, in some embodiments, providing (e.g., in act 14) the immersive reality experience (e.g., to one or more users) includes proactively pushing the immersive reality experience (e.g., to one or more users). Even further, in some embodiments, collecting (e.g., in act 16) the (e.g., at least one of quantitative or qualitative) data, for instance, from the one or more users, for example, during the immersive reality experience (e.g., provided in act 14) includes (e.g., in act 15) displaying questions (e.g., during the immersive reality experience, for instance, provided in act 14) and measuring (e.g., in act 16) responses to the questions (e.g., provided in act 15).

Further, various embodiments of the subject matter described herein include various combinations of the acts, structure, components, and features described herein, or that are known in the art. Moreover, certain procedures can include acts such as manufacturing, obtaining, or providing components that perform functions described herein or in any documents that are incorporated by reference. The subject matter described herein also includes various means for accomplishing the various functions or acts described herein, or that are apparent from the structure and acts described. Each function described herein is also contemplated as a means for accomplishing that function, or where appropriate, as a step for accomplishing that function. Further, as used herein, the word “or”, except where indicated otherwise, does not imply that the alternatives listed are mutually exclusive. Even further, where alternatives are listed herein, it should be understood that in some embodiments, fewer alternatives may be available, or in particular embodiments, just one alternative may be available, as examples.

What is claimed is:

1. A method of collecting at least one of quantitative or qualitative data, the method comprising at least acts of:
providing an immersive reality experience to one or more users; and,
collecting the at least one of quantitative or qualitative data from the one or more users during the immersive reality experience.

2. The method of claim 1 wherein the collecting the at least one of quantitative or qualitative data from the one or more users is performed while the one or more users are interacting with the immersive reality experience.

3. The method of claim 1 further comprising: prompting the one or more users with questions during the immersive reality experience; and collecting responses to the questions.

4. The method of claim 1 further comprising: monitoring interaction behavior of the one or more users during the immersive reality experience; and collecting the interaction behavior.

5. The method of claim 1 wherein collecting the at least one of quantitative or qualitative data from the one or more users during the immersive reality experience comprises displaying questions during the immersive reality experience and measuring responses to the questions.

6. The method of claim 1 further comprising: providing a platform to the one or more users, wherein: the platform comprises at least one of a device app, a web portal, a Software Developer Kit (SDK), or software; and the providing of the immersive reality experience to one or more users comprises using the platform.

7. The method of claim 6 wherein the collecting of the at least one of quantitative or qualitative data from the one or more users during the immersive reality experience comprises using the platform.

8. The method of claim 6 further comprising: using the platform to, at least one of: report, publish, or transmit the at least one of quantitative or qualitative data from the one or more users.

9. The method of claim 1 further comprising at least one of: reporting, publishing, or transmitting the at least one of quantitative or qualitative data from the one or more users.

10. The method of claim 1 wherein the immersive reality experience comprises at least one 360 degree photograph or video.

11. The method of claim 1 wherein the immersive reality experience is presented in a two-dimensional format.

12. The method of claim 1 wherein the immersive reality experience is presented in a three-dimensional format.

13. The method of claim 1 wherein the immersive reality experience comprises at least one of two-dimensional or three-dimensional positional data.

14. The method of claim 1 wherein the immersive reality experience comprises at least one hologram.

15. The method of claim 1 wherein the immersive reality experience comprises at least one human-machine interaction generated by computer technology that includes at least one of a wearable device or an IoT device.

16. The method of claim 1 wherein the immersive reality experience comprises one or more of Virtual Reality (VR), Augmented Reality (AR), or Mixed Reality (MR).

17. The method of claim 1 further comprising: using an application programming interface or software developer kit to conduct at least one of research, surveys, questionnaires, or remote communication within the immersive reality experience.

18. The method of claim 17 wherein the immersive reality experience is hosted by a third-party.

19. The method of claim 1 wherein the immersive reality experience is enabled with at least one of: remote communication, moderation, or speech to text translation.

20. The method of claim 1 wherein providing the immersive reality experience to one or more users comprises proactively pushing the immersive reality experience to one or more users.
